(19) United States
(12) Patent Application Publication
(10) Pub. No.: US 2024/0232710 A1
(43) Pub. Date: Jul. 11, 2024

(54) METHODS AND SYSTEMS FOR TRAINING A DECISION-TREE BASED MACHINE LEARNING ALGORITHM (MLA)

(71) Applicant: Direct Cursus Technology L.L.C, Dubai (AE)

(72) Inventors: Lyudmila PROKHORENKOVA, Moscow (RU); Aleksei USTIMENKO, Ivanovo (RU)

(21) Appl. No.: 18/395,024

(22) Filed: Dec. 22, 2023

(30) Foreign Application Priority Data
Dec. 23, 2022 (RU) 2022134041

(51) Int. Cl. G06N 20/00; G06N 5/01

(52) U.S. Cl. CPC G06N 20/00; G06N 5/01

(57) ABSTRACT

Methods and processors for training a decision-tree based Machine Learning Algorithm (MLA) are disclosed. During a first training iteration, the processor generates a first tree, which includes generating a first tree structure with leaf nodes. The at least one from the plurality of training objects falling in one leaf node and none falling in an other node. The leaf values being based on a first noise-inducing function such that they are non-null leaf values. During a second training iteration of the decision-tree based MLA, the processor generates a second tree with a second tree structure with a third leaf node. A third leaf value is based on an estimated gradient value of a loss function for at least one training object falling in the third leaf node. The processor is configured to store the first and the second tree of the decision-tree based MLA in a storage.

### CROSS-REFERENCE

The present application claims priority to Russian Patent Application No. 2022134041, entitled “Methods and Systems for Training a Decision-Tree Based Machine Learning Algorithm (MLA)”, filed Dec. 23, 2022, the entirety of which is incorporated herein by reference.

### FIELD

The present technology relates to systems and methods for generating machine-learning models. In particular, the present technology is directed to a method of and a system for training a decision-tree based Machine Learning Algorithm.

### BACKGROUND

Machine learning algorithms (MLAs) are used to address multiple needs in computer-implemented technologies. Typically, the MLAs are used for generating a prediction based on data provided thereto.

The volume of available information through various Internet resources has grown exponentially in the past couple of years. Several solutions have been developed in order to allow a typical user to find the information that the user is looking for. One example of such a solution is a search engine. Examples of the search engines include GOOGLE™ search engine, YANDEX™ search engine, YAHOO!™ search engine and the like. The user can access the search engine interface and submit a search query associated with the information that the user is desirous of locating on the Internet. In response to the search query, the search engine provides a ranked list of search results. The ranked list of search results is generated based on various ranking algorithms employed by the particular search engine that is being used by the user performing the search. The overall goal of such ranking algorithms is to present the most relevant search results at the top of the ranked list, while less relevant search results would be positioned on less prominent positions of the ranked list of search results (with the least relevant search results being located towards the bottom of the ranked list of search results).

The search engines typically provide a good search tool for a search query that the user knows apriori that she/he wants to search. In other words, if the user is interested in obtaining information about the most popular destinations in Italy (i.e. a known search topic), the user could submit a search query: “The most popular destinations in Italy?” The search engine will then present a ranked list of Internet resources that are potentially relevant to the search query. The user can then browse the ranked list of search results in order to obtain information she/he is interested in as it related to places to visit in Italy. If the user, for whatever reason, is not satisfied with the uncovered search results, the user can re-run the search, for example, with a more focused search query.

In the search engine example, the MLA is used for generating the ranked search results. When the user submits a search query, the search engine generates a list of relevant web resources (based on an analysis of crawled web resources, an indication of which is stored in a crawler database in a form of posting lists or the like). The search engine then executes the MLA to rank the so-generated list of search results. The MLA ranks the list of search results based on their relevancy to the search query. Such the MLA is “trained” to predict relevancy of the given search result to the search query based on a plethora of “features” associated with the given search result, as well as indications of past users' interactions with search results when submitting similar search queries in the past.

As has been alluded to above, the search engines are useful when the user knows what the user is looking for (i.e. has a particular search intent in mind). There is another approach that has been proposed for allowing the user to discover content and, more precisely, to allow for discovering and/or recommending content that the user may not be expressly interested in searching for. In a sense, such systems recommend content to the user without an express search request based on explicit or implicit interests of the user.

An example of such a system is a FLIPBOARD™ recommendation system, which system aggregates and recommends content from various social networks. The FLIPBOARD recommendation system presents the uncovered content in a “magazine style” format, where the user can “flip” through the pages with the recommended/aggregated content. The recommendation system collects content from social media and other websites, presents it in magazine format, and allows users to “flip” through their social-networking feeds and feeds from websites that have partnered with the company, effectively “recommending” content to the user even though the user may not have expressly expressed her/his desire in the particular content. Another example of a recommendation system is YANDEX.ZEN™ recommendation system, which generates and presents user-personalized content to the user when the user initiates an application associated with Yandex.Zen, which can be a dedicated application or a landing page of a browser application.

In order to generate the ranked search results in a search engine system or a list of recommended resources in a typical recommendation system, the respective system utilizes the MLA the recommended content from various content sources available on the Internet. There are many different types of MLAs known in the art. Broadly speaking, there are three types of MLAs: supervised learning based MLAs, unsupervised learning based MLAs and reinforcement learning based MLAs.

One example of supervised learning MLAs are Decision-tree models. This type of MLAs uses a decision tree to go from observations about an item (represented in the branches) to conclusions about the item's target value (represented in the leaves). Tree models where the target variable can take a discrete set of values are called classification trees; in these tree structures, leaves represent class labels and branches represent conjunctions of features that lead to those class labels. Decision trees where the target variable can take continuous values (typically real numbers) are called regression trees.

In order for the decision-tree based MLA to work, it needs to be “built” or trained using a training set of objects containing a large plurality of training objects (such as documents, events, or the like).

### SUMMARY

Embodiments of the present technology have been developed based on developers' appreciation of at least one technical problem associated with the prior art approaches to building decision trees.

### Gradient Boosting

Developers of the present technology have identified one or more drawbacks of a “Gradient Boosting” (GB) method for building a decision-tree Machine Learning Algorithm (MLA). Broadly speaking, GB is a powerful machine-learning method that iteratively combines weak models to obtain more accurate ones. Nowadays, this machine-learning technique is one of the most common ones for training MLAs used for web search, recommendation systems, weather forecasting, and many other problems with complex dependencies and heterogeneous data.

### Stochastic Gradient Boosting

One variant of this machine-learning technique is called “Stochastic Gradient Boosting” (SGB), where during each training iteration, a subset of training objects is randomly chosen for building a tree during that training iteration. Additional information regarding the implementation of the GB and SGB techniques can be found in an article, entitled “Stochastic Gradient Boosting”, published on Mar. 26, 1999, by Jerome H. Friedman, the contents of which are incorporated herein by reference in its entirety.

Developers of the present technology have realized that DB techniques may be adapted for convex, as well as non-convex optimization. It should be noted that one of the differences between convex and non-convex loss functions is that the latter ones have stationary points such as local minimums or also known as “saddle points”. In contrast, a stationary point in a convex function is a global minimum thereof.

In typical GB algorithms, a decision-tree based MLA can be built to make predictions that yield a lower value of a loss function. It can be said that conventional GB allows creating an additional tree with each training iteration such that it results, in a sense, in “travelling” along a given loss function towards a lower value thereof. When performing convex optimization (using a convex loss function), using GB results in “travelling” towards the global minimum of that convex loss function.

### Stochastic Gradient Langevin Boosting

However, when performing non-convex optimization (using a non-convex loss function), it may not always be the case that using SGB will result in “travelling” towards the global minimum, but rather towards a local minimum (saddle point). Developers of the present technology have realized that a Stochastic Gradient Langevin Boosting (SGLB) technique can be used to mitigate at least some drawbacks of using non-convex optimization.

Some implementations of the SGLB technique used to tackle at least some inconveniences of non-convex optimization are disclosed in an article entitled “SGLB: Stochastic Gradient Langevin Boosting”, authored by Aleksei Ustimenko and Liudmila Prokhorenkova, and published on 16 Jan., 2022, the contents of which is incorporated herein by reference in its entirety. At least some other implementations of the SGLB algorithm are disclosed in a co-owned US patent publication no. 2022/0019902, published on Jan. 20, 2022, the content of which is incorporated herein by reference in its entirety.

Broadly, in the SGLB framework, “noise” is injected during the training phase of the decision-tree based MLA which, in a sense, allows “jumping” between different saddles of a non-convex loss function. Hence, subsequent training iterations may not necessarily “travel” towards a same potentially local minimum, and instead, will generally “travel” towards lower values of the non-convex loss function. The SGLB algorithm enables both exploitation and exploration of data during training so as to globally converge, even if employed with a non-convex loss function.

Developers of the present technology have realized at least some drawbacks associated with the SGLB framework. First, convergence of an SGLB model to an optimal solution may be slow and asymptotical. Second, during in-use, when an object “falls” into leaf nodes for which training data was not available, the object falls into a leaf node with a null leaf value, and the SGLB model provides a signal indicative of being highly certain in its prediction. Developers have realized that a signal indicative of high certainty for such an object may be problematic during use of the SGLB model.

In at least some embodiments of the present technology, developers have devised a GB algorithm that can converge comparative faster to the convergence of an SGLB model. It is contemplated that in some embodiments of the present technology, developers have devised methods and system for determining which leaf values can be assigned to leaf nodes in which no training data fell during training.

Developers of the present technology appreciate some existing solutions called “kernel methods”. Broadly, such methods employ instance-based learners—i.e., rather than learning some fixed set of parameters corresponding to the features of their inputs, learners instead “remember” an i^{th} training example and learn a corresponding weight. Developers of the present technology have realized that a model built using kernel methods may converge exponentially.

### Kernel Gradient Boosting

In the context of the present technology, developers have devised a Kernel Gradient Boosting (KGB) model in which different “types” of trees are built. For a first set of trees, a first algorithm may be executed for sampling from a posterior distribution. An example of a first algorithm is as follows:

Algorithm 3 SamplePrior(T, m, n)

```
hyper-parameters: number of iterations T, parameters of SampleTree m, n
instructions:
initialize τ = 0, h₀(x) = 0
repeat
  ν_{τ} = SampleTree( [symbol]  ; m, n, 1) - sample
  random tree
  ${θ}_{τ} ∼ 𝒩 ( {𝕆}_{{ℝ}^{{L}_{{v}_{τ}}}} , diag ( \frac{N}{max \{ {N}_{{v}_{τ}}^{( j )} , 1 \}} : j ∈ \{ 1 , … , {L}_{{v}_{τ}} \} ) ) - generate random values$
  in leaves
  ${h}_{τ + 1} ( \cdot ) = {h}_{τ} ( \cdot ) + \frac{1}{\sqrt{T}} {〈 {ϕ}_{{v}_{r}} ( \cdot ) , {θ}_{τ} 〉}_{{ℝ}^{{L}_{{v}_{τ}}}} - update model$
  τ = τ +1
until τ ≥ T
return: hp(•)
```

wherein: υ_{τ} refers to a given tree structure, m refers to a depth of a given tree, n refers to a number of intervals used for splitting operations, θ_{τ} refers to leaf values, h represents a current version of a model, N refers to a total number of objects in the training dataset, N_{υ}_{_{τ}}^{(j)} refers to a number of objects falling in a given leaf node j.

In this specific implementation, the SamplePrior algorithm generates an ensemble of random trees, with tree structures having random “splits” and leaf nodes assigned with random values. It should be noted that although a tree structure is a “uniformly-distributed” structure, the tree structure may still at least partially depend on dataset features, since split values are based on those features. It is contemplated that the set of first trees may include a single first tree, without departing from the scope of the present technology.

Following execution of a pre-determined number of iterations of the first algorithm to obtain a first sub-model (one or more first trees), a second sub-model may be trained. The second sub-model may be embodied as a GBDT model. The KGB model is implemented as a combination of the first sub-model and the second sub-model. An example of an algorithm that can be executed for generating the KGB model is as follows:

Algorithm 4 SamplePosterior(z; ϵ, T₁, T₀, m, n, β, σ, δ)

input: dataset z = (x_{N}, y_{N})
hyper-parameters: learning rate ϵ > 0, boosting
iteration T₁, SamplePrior iterations T₀, parameters
of SampleTree m, n, β, kernel scale σ > 0 (default
σ = 1), noise scale δ > 0 (default: δ = 0.01)
instructions:
h_{T}_{₀}, (•) = SamplePrior(T₀, m, n)
y_{N}^{new} = y_{N} − σh_{T}_{₀} (x_{N}) + [symbol] ( [symbol] , δ² I_{N})
${f}_{{T}_{1}} ( \cdot ) = TrainGBDT ( ( {x}_{N} , {y}_{N}^{new} ) ; ϵ , {T}_{1} , m , n , β , \frac{{δ}^{2}}{{σ}^{2}} )$
return: σh_{T}_{₀}(•) + f_{T}_{₁}(•)

wherein X_{N} refers to features associated with N training objects, Y_{N} refers to labels associated with the N training objects, β refers to a temperature of randomization parameter during the tree building process, f_{T}_{₁} (⋅) refers to a second sub-model.

In this specific implementation, a GBDT algorithm generates a set of second trees. It is contemplated that a variety of GBDT algorithms may be employed for generating the set of second trees.

### A First Tree of the First Sub-Model

During execution of the first algorithm, noise is injected such that leaf values of leaf nodes of the set of first trees are exclusively non-null. It is contemplated that a first noise-injecting function may yield a first option for leaf values for leaf nodes in which objects fell, and a second option for leaf values of leaf nodes in which none of the objects fell.

As alluded to above, a given tree structure of a given first tree in the first model may be “randomly” selected, meaning that a likelihood of the given first tree having the given tree structure is equal to a likelihood of the given first tree having any other potential tree structure. In some embodiments, the given tree structure may be generated using a beam search algorithm. The split values for a given tree structure may be determined based on the training dataset. It can be said that thresholds may be randomly selected during a splitting operation.

In this embodiment, once the training dataset is inputted into the first tree, a number of objects in respective leaf nodes of the given tree structure may be determined. Leaf values are then assigned in a particular manner to the respective leaf nodes.

A first noise-inducing function may be used to generate the leaf values. It is contemplated that the first noise-inducing function may be pre-selected such that a dispersion of leaf values in the corresponding leaf nodes is proportional to a size of the training dataset. In one implementation, the first noise-inducing function may generate random gaussian values for the respective leaf nodes with a dispersion equal to a size of the training dataset divided by a maximum value between (i) a number of objects in a corresponding leaf node and (ii) “1”.

Developers of the present technology have realized that so-determining the leaf values for the leaf nodes of the given first tree, when in-use objects fall into those leaves, the KGB model provides a signal indicative of comparatively lower certainty of prediction than when in-use objects fall into leaf nodes with otherwise-null leaf values. Developers of the present technology have realized that the first set of trees allows the KGB model not to necessarily converge to a same result every time it's trained.

It should be noted that the training dataset comprises a plurality of training objects and respective labels representative of ground-truth about corresponding training objects. It is contemplated that although the plurality of training objects are used during generation of the set of first trees, the respective labels are not actually used. In contrast, both the plurality of training objects and the respective labels are used during generation of the set of second trees.

### A Second Tree of the Second Sub-Model

In some embodiments, a given second tree may be generated using a GB method with a randomized three structure generation process. In some embodiments, an SGLB approach may be used to generate the set of second trees. It is contemplated however that an SGLB approach without leaf value randomization may be applied.

Developers of the present technology have realized that when a given in-use object has been encountered during training of the KGB model, the set of second trees is responsible to generate a “correct” prediction for this in-use object. However, when the given in-use object has not been encountered during training, the first set of trees is responsible for providing an indication of uncertainty of prediction.

Developers of the present technology have performed empirical evaluation of a proposed KGB algorithm which demonstrate better knowledge uncertainty estimates than at least some other GBDT algorithms.

A following Table 1 shows a comparison of the predictive performances of a KGB algorithm, a SGB algorithm, and a SGLB algorithm and their corresponding ensembles, on several regression datasets:

TABLE 1
Predictive performance, RMSE

| | Single | | | Ensemble | | |
|---|---|---|---|---|---|---|
| Dataset | SGB | SGLB | KGB | SGB | SGLB | KGB |
| Boston | 3.06 | 3.12 | 2.81 | 3.04 | 3.10 | 2.82 |
| Concrete | 5.21 | 5.11 | 4.36 | 5.21 | 5.10 | 4.30 |
| Energy | 0.57 | 0.54 | 0.33 | 0.57 | 0.54 | 0.33 |
| Kin8nm | 0.14 | 0.14 | 0.11 | 0.14 | 0.14 | 0.10 |
| Naval | 0.00 | 0.00 | 0.00 | 0.00 | 0.00 | 0.00 |
| Power | 3.55 | 3.56 | 3.48 | 3.52 | 3.54 | 3.43 |
| Protein | 3.99 | 3.99 | 3.79 | 3.99 | 3.99 | 3.76 |
| Wine | 0.63 | 0.63 | 0.61 | 0.63 | 0.63 | 0.60 |
| Yacht | 0.82 | 0.84 | 0.52 | 0.83 | 0.84 | 0.50 |
| Year | 8.99 | 8.96 | 8.97 | 8.97 | 8.93 | 8.94 |

Data in table 1 has been obtained by performing cross-validation to estimate statistical significance with paired t-test. The data in table 1 also highlights in bold the approaches that are insignificantly different from the best one (p-value>0.05). Developers have realized that the predictive performance of the KGB model and of the KGB ensemble is improved on almost all datasets if compared to the the other models.

Developers of the present technology have performed additional empirical evaluation of the proposed KGB algorithm which demonstrate that the proposed KGB algorithm outperforms the baselines for out-of-domain detection. It should be noted that detection errors can be evaluated via the Prediction-Rejection Ratio (PRR). Broadly, PRR measures how well uncertainty estimates correlate with errors and rank-order them. Out-of-domain (OOD) detection is usually assessed via the area under the ROC curve (AUC-ROC).

A following Table 2 shows a comparison of error and ODD detection of a KGB algorithm, a SGB algorithm, and a SGLB algorithm and their corresponding ensembles, on several regression datasets:

TABLE 2
Error and OOD detection

| | PRR | | | AUC | | |
|---|---|---|---|---|---|---|
| Dataset | SGB | SGLB | KGB | SGB | SGLB | KGB |
| Boston | 36 | 37 | 43 | 80 | 80 | 88 |
| Concrete | 29 | 29 | 37 | 92 | 92 | 93 |
| Energy | 36 | 31 | 60 | 100 | 100 | 99 |
| Kin8nm | 18 | 19 | 20 | 45 | 45 | 41 |
| Naval | 55 | 56 | 35 | 100 | 100 | 100 |
| Power | 8 | 9 | 31 | 72 | 73 | 76 |
| Protein | 30 | 29 | 35 | 99 | 99 | 100 |
| Wine | 25 | 19 | 37 | 74 | 72 | 87 |
| Yacht | 74 | 78 | 86 | 62 | 60 | 69 |
| Year | 30 | 30 | 32 | 67 | 57 | 71 |

Data in Table 2 shows that the KGB method outperforms the baselines for out-of-domain detection. These improvements can be explained by the theoretical soundness of KGB: convergence properties are theoretically grounded and non-asymptotic. In contrast, for SGB, for example, there are no general results applicable in our setting, while for SGLB method, for example, the guarantees are asymptotic.

In some embodiments of the present technology, the KGB technique can be implemented as a part of the CatBoost library. The CatBoost library and additional information regarding gradient boosting algorithms is available at https://catboost.ai. Thus it can be said, at least some embodiments of the present technology can be implemented in accordance with the CatBoost framework.

In a first broad aspect of the present technology, there is provided a method of training a decision-tree based Machine Learning Algorithm (MLA), the method executable by a processor having access to a training dataset. The training dataset comprises a plurality of training objects and a plurality of target values for respective ones from the plurality of training objects. The method comprises during a first training iteration of the decision-tree based MLA: generating, by the processor, a first tree using the plurality of training objects. The generating includes: generating a first tree structure with a first leaf node and a second leaf node, at least one from the plurality of training objects falling in the first leaf node and none falling in the second leaf node; and generating a first leaf value for the first leaf node and a second leaf value for the second leaf node, the first and second leaf values being based on a first noise-inducing function such that the first leaf value and the second leaf value are non-null leaf values. The method comprises during a second training iteration of the decision-tree based MLA: generating, by the processor, a second tree using the training dataset. The generating includes: generating a second tree structure with a third leaf node; and generating a third leaf value to the third leaf node, the third leaf value being based on an estimated gradient value of a loss function for at least one training object falling in the third leaf node. The method comprises storing, by the processor, the first and the second tree of the decision-tree based MLA in a storage.

In some embodiments of the method, the first tree structure has a plurality of leaf nodes including the first leaf node and the second lead node, and wherein all leaf values assigned to the plurality of lead nodes using the first noise-inducing function are exclusively non-null leaf values.

In some embodiments of the method, the first tree structure is a uniformly-distributed tree structure.

In some embodiments of the method, the second tree structure is generated using a second noise-inducing function.

In some embodiments of the method, the generating the second tree comprises generating, by the server, the second tree structure using a Gradient Boosting (GB) technique.

In some embodiments of the method, the GB technique includes a randomized tree generation process.

In some embodiments of the method, the method comprises generating, by the processor, a plurality of first trees during a plurality of first training iterations, the first training iteration being one from the plurality of first training iterations, the first tree being one from the plurality of first trees.

In some embodiments of the method, the method comprises generating, by the processor, a plurality of second trees during a plurality of second training iterations, the second training iteration being one from the plurality of second training iterations, the second tree being one from the plurality of second trees.

In some embodiments of the method, the decision-tree based MLA is being trained for performing a regression task during an in-use phase of the decision-tree based MLA.

In some embodiments of the method, the decision-tree based MLA is being trained for performing a classification task during an in-use phase of the decision-tree based MLA.

In some embodiments of the method, the first noise-inducing function is a function having a null average and a finite distribution.

In some embodiments of the method, the loss function is at least one of a 0-1 loss, Normalized Discounted Cumulative Gain (NDCG), and PFound.

In some embodiments of the method, the loss function is at least one of a hinge loss, logistic loss, and squared error loss.

In a second broad aspect of the present technology, there is provided a processor for training a decision-tree based Machine Learning Algorithm (MLA). The processor has access to a training dataset. The training dataset comprises a plurality of training objects and a plurality of target values for respective ones from the plurality of training objects. The processor is configured to during a first training iteration of the decision-tree based MLA: generate a first tree using the plurality of training objects. To generate the first tree, the processor is configured to: generate a first tree structure with a first leaf node and a second leaf node, at least one from the plurality of training objects falling in the first leaf node and none falling in the second leaf node; and generate a first leaf value for the first leaf node and a second leaf value for the second leaf node, the first and second leaf values being based on a first noise-inducing function such that the first leaf value and the second leaf value are non-null leaf values. The processor is configured to during a second training iteration of the decision-tree based MLA. To generate the second tree includes the processor configured to: generate a second tree structure with a third leaf node; and generate a third leaf value to the third leaf node, the third leaf value being based on an estimated gradient value of a loss function for at least one training object falling in the third leaf node. The processor is configured to store the first and the second tree of the decision-tree based MLA in a storage.

In some embodiments of the processor, the first tree structure has a plurality of leaf nodes including the first leaf node and the second lead node, and wherein all leaf values are generated for the plurality of lead nodes using the first noise-inducing function are exclusively non-null leaf values.

In some embodiments of the processor, the first tree structure is a uniformly-distributed tree structure.

In some embodiments of the processor, the second tree structure is generated using a second noise-inducing function.

In some embodiments of the processor, the generating the second tree comprises generating, by the server, the second tree structure using a Gradient Boosting (GB) technique.

In some embodiments of the processor, the GB technique includes a randomized tree generation process.

In some embodiments of the processor, the processor is configured to generate a plurality of first trees during a plurality of first training iterations, the first training iteration being one from the plurality of first training iterations, the first tree being one from the plurality of first trees.

In some embodiments of the processor, the processor is configured to generate a plurality of second trees during a plurality of second training iterations, the second training iteration being one from the plurality of second training iterations, the second tree being one from the plurality of second trees.

In some embodiments of the processor, the decision-tree based MLA is being trained for performing one a regression task during an in-use phase of the decision-tree based MLA.

In some embodiments of the processor, the decision-tree based MLA is being trained for performing one a classification task during an in-use phase of the decision-tree based MLA.

In some embodiments of the processor, the first noise-inducing function is a function having a null average and a finite distribution.

In some embodiments of the processor, the loss function is at least one of a 0-1 loss, Normalized Discounted Cumulative Gain (NDCG), and PFound.

In some embodiments of the processor, the loss function is at least one of a hinge loss, logistic loss, and squared error loss.

In the context of the present specification, unless expressly provided otherwise, an “electronic device”, an “electronic device”, a “server”, a, “remote server”, and a “computer-based system” are any hardware and/or software appropriate to the relevant task at hand. Thus, some non-limiting examples of hardware and/or software include computers (servers, desktops, laptops, netbooks, etc.), smartphones, tablets, network equipment (routers, switches, gateways, etc.) and/or combination thereof.

In the context of the present specification, unless expressly provided otherwise, the expression “computer-readable medium” and “memory” are intended to include media of any nature and kind whatsoever, non-limiting examples of which include RAM, ROM, disks (CD-ROMs, DVDs, floppy disks, hard disk drives, etc.), USB keys, flash memory cards, solid state-drives, and tape drives.

In the context of the present specification, unless expressly provided otherwise, an “indication” of an information element may be the information element itself or a pointer, reference, link, or other indirect mechanism enabling the recipient of the indication to locate a network, memory, database, or other computer-readable medium location from which the information element may be retrieved. For example, an indication of a document could include the document itself (i.e. its contents), or it could be a unique document descriptor identifying a file with respect to a particular file system, or some other means of directing the recipient of the indication to a network location, memory address, database table, or other location where the file may be accessed. As one skilled in the art would recognize, the degree of precision required in such an indication depends on the extent of any prior understanding about the interpretation to be given to information being exchanged as between the sender and the recipient of the indication. For example, if it is understood prior to a communication between a sender and a recipient that an indication of an information element will take the form of a database key for an entry in a particular table of a predetermined database containing the information element, then the sending of the database key is all that is required to effectively convey the information element to the recipient, even though the information element itself was not transmitted as between the sender and the recipient of the indication.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein. Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a schematic illustration of a system as in accordance to at least some non-limiting embodiments of the present technology.

FIG. 2 is a schematic illustration an in-use iteration of a decision-tree based Machine Learning Algorithm (MLA) of the system of FIG. 1, in accordance with at least some non-limiting embodiments of the present technology.

FIG. 3 is a schematic illustration of a set of first trees and a set of second trees forming the decision-tree based MLA of FIG. 2, in accordance with at least some non-limiting embodiments of the present technology.

FIG. 4 is a schematic illustration of a training iteration of a first tree from the set of first trees of FIG. 3 and a training iteration of a second tree from the set of second trees of FIG. 3, in accordance with at least some non-limiting embodiments of the present technology.

FIG. 5 is a scheme-block representation of a method of training the decision-tree based MLA of FIG. 2 by a server of FIG. 1, as envisioned in at least some non-limiting embodiments of the present technology.

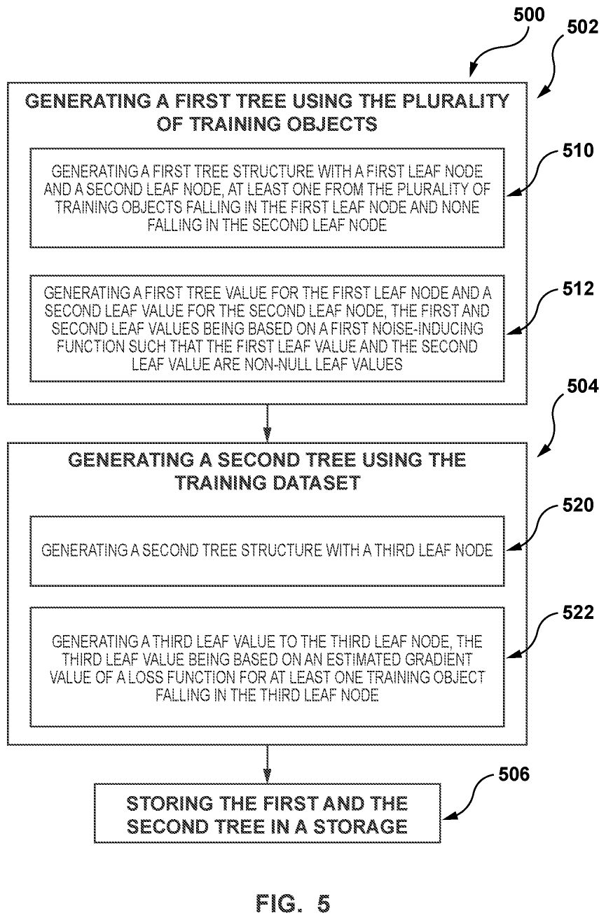

An Appendix A is provided at the end of the present specification. The Appendix A includes a copy of an article entitled “Gradient Boosting Performs Low-Rank Gaussian Process Inference”. This article provides additional background information, description of implementations of the non-limiting embodiments of the present technology, as well as some additional examples. The entirety of this article is incorporated herein by reference in their entirety, in all those jurisdictions where such incorporation by reference is allowed.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor” or a “graphics processing unit”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some embodiments of the present technology, the processor may be a general purpose processor, such as a central processing unit (CPU) or a processor dedicated to a specific purpose, such as a graphics processing unit (GPU). Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

With these fundamentals in place, we will now consider some non-limiting examples to illustrate various implementations of aspects of the present technology.

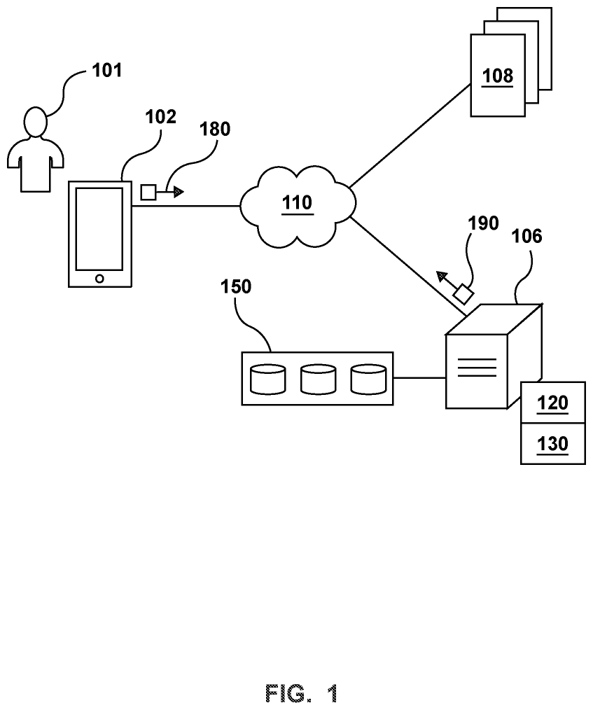

Referring to FIG. 1, there is shown a schematic diagram of a system 100, the system 100 being suitable for implementing non-limiting embodiments of the present technology. It is to be expressly understood that the system 100 as depicted is merely an illustrative implementation of the present technology. Thus, the description thereof that follows is intended to be only a description of illustrative examples of the present technology.

Broadly speaking and as an example, the system 100 may be employed for providing search results to a given user in response to a query submitted thereby. To that end, the system 100 comprises inter alia an electronic device 102 associated with the user 101, a server 106, a plurality of resource servers 108 and a database system 150. For example, the user 101 may submit a given query via the electronic device 102 to the server 106 which, in response, is configured to provide search results to the user 101. The server 106 generates these search results based on information that has been retrieved from, for example, the plurality of resource servers 108 and stored in the database system 150. These search results provided by the system 100 may be relevant to the submitted query. It should be noted that the system 100 can be configured as another type of a computer-based platform, such as a recommendation system, a classification system, or the like. Some functionality of components of the system 100 will now be described in greater detail.

### Electronic Device

As mentioned above, the system 100 comprises the electronic device 102 associated with the user 101. As such, the electronic device 102, or simply “device” 102 can sometimes be referred to as a “client device”, “end user device” or “client electronic device”. It should be noted that the fact that the electronic device 102 is associated with the user 101 does not need to suggest or imply any mode of operation—such as a need to log in, a need to be registered, or the like.

In the context of the present specification, unless provided expressly otherwise, “electronic device” or “device” is any computer hardware that is capable of running a software appropriate to the relevant task at hand. Thus, some non-limiting examples of the device 102 include personal computers (desktops, laptops, netbooks, etc.), smartphones, tablets and the like. The device 102 comprises hardware and/or software and/or firmware (or a combination thereof), as is known in the art, to execute a given browser application (not depicted).

Generally speaking, the purpose of the given browser application is to enable the user 101 to access one or more web resources. How the given browser application is implemented is not particularly limited. One example of the given browser application that is executable by the device 102 may be embodied as a Yandex™ browser. For example, the user 101 may use the given browser application to (i) navigate to a given search engine website, and (ii) submit a query in response to which (s)he is to be provided with relevant search results.

The device 102 is configured to generate a request 180 in response to the user 101 submitting a query. The request 180 may take form of one or more data packets comprising information indicative of the query submitted by the user 101. The device 102 is also configured to receive a response 190. The response 190 may take form of one or more data packets comprising information indicative of search results that are relevant to the submitted query and computer-readable instructions for displaying by the given browser application to the user 101 these search results. How the content of the response 190 is generated in response to the submitted query will be described in greater details herein further below.

### Communication Network

The system 100 comprises a communication network 110. In one non-limiting example, the communication network 110 may be implemented as the Internet. In other non-limiting examples, the communication network 110 may be implemented differently, such as any wide-area communication network, local-area communication network, a private communication network and the like. In fact, how the communication network 110 is implemented is not limiting and will depend on inter alia how other components of the system 100 are implemented.

The purpose of the communication network 110 is to communicatively couple at least some of the components of the system 100 such as the device 102, the plurality of resource servers 108 and the server 106. For example, this means that the plurality of resource servers 108 is accessible via the communication network 110 by the device 102. In another example, this means that the plurality of resource servers 108 is accessible via the communication network 110 by the server 106. In a further example, this means that the server 106 is accessible via the communication network 110 by the device 102.

The communication network 110 may be used in order to transmit data packets amongst the device 102, the plurality of resource servers 108 and the server 106. For example, the communication network 110 may be used to transmit the request 180 from the device 102 to the server 106. In another example, the communication network 110 may be used to transmit the response 190 from the server 106 to the device 102.

### Plurality of Resource Servers

As mentioned above, the plurality of resource servers 108 can be accessed via the communication network 110. The plurality of resource servers 108 may be implemented as conventional computer servers. In a non-limiting example of an embodiment of the present technology, a given one of the plurality of resource servers 108 may be implemented as a Dell™ PowerEdge™ Server running the Microsoft™ Windows Server™ operating system. The given one of the plurality of resource servers 108 may also be implemented in any other suitable hardware and/or software and/or firmware or a combination thereof.

The plurality of resource servers 108 are configured to host (web) resources that can be accessed by the device 102 and/or by the server 106. Which type of resources the plurality of resource servers 108 is hosting is not limiting. However, in some embodiments of the present technology, the resources may comprise digital documents, or simply “documents”, that are representative of web pages.

For example, the plurality of resource servers 108 may host web pages, which means that the plurality of resource servers 108 may store documents representative of web pages and which are accessible by the device 102 and/or by the server 106. A given document may be written in a mark-up language and may comprise inter alia (i) content of a respective web page and (ii) computer-readable instructions for displaying the respective web page (content thereof).

A given one of the plurality of resource servers 108 may be accessed by the device 102 in order to retrieve a given document stored on the given one of the plurality of resource servers 108. For example, the user 101 may enter a web address associated with a given web page in the given browser application of the device 102 and, in response, the device 102 may access a given resource server hosting the given web page in order to retrieve the document representative of the given web page for rendering the content of the web page via the given browser application.

A given one of the plurality of resource servers 108 may be accessed by the server 106 in order to retrieve a given document stored on the given one of the plurality of resource servers 108. The purpose for the server 106 accessing and retrieving documents from the plurality of resource servers 108 will be described in greater detail herein further below.

### Database System

The server 106 is communicatively coupled to the database system 150. Generally speaking, the database system 150 is configured to acquire data from the server 106, store the data, and/or provide the data to the server 106 for further use.

In some embodiments, the database system 150 may be configured to store information associated with a search engine hosted by the server 106. For example, the database system 150 may store information about previously performed searches by the search engine. Also, the database system 150 may store information about previously submitted queries to the server 106 and about documents that have been provided by the search engine of the server 106 as search results. As it will become apparent from the description herein further below, the database system 150 may also be configured to store an indexing structure to be used by the search engine of the server 106, such as an inverted index including term-specific posting lists of documents that contain the respective search terms.

It is contemplated that the database system 150 may store query data associated with respective queries submitted to the search engine. Query data associated with a given query may be of different types and is not limiting. For example, the database system 150 may store query data for respective queries such as, but not limited to:
popularity of a given query;
frequency of submission of the given query;
number of clicks associated with the given query;
indications of other submitted queries associated with the given query;
indications of documents associated with the given query;
other statistical data associated with the given query;
search terms associated with the given query;
number of characters within the given query; and
other query-intrinsic characteristics of the given query.

The database system 150 may also store document data associated with respective documents. Document data associated with a given document may be of different types and is not limiting. For example, the database system 150 may store document data for respective documents such as, but not limited to:
popularity of a given document;
click-through-rate for the given document;
time-per-click associated with the given document;
indications of queries associated with the given document;
other statistical data associated with the given document;
text associated with the given document;
file size of the given document; and
other document-intrinsic characteristics of the given document.

In at least some embodiments, it is contemplated that the database system 150 may be configured to store data in association with “document-query” pairs. For example, the database system 150 may be configured to store a list of documents in association with one or more queries for which they have been provided as search results by the search engine.

Furthermore, it is contemplated that the database system 150 may be configured to store label data associated with a given document and/or with a given document-query pair. Broadly speaking, label data contains information indicative of “ground-truth” about a respective document and/or a respective document-query pair. For example, label data associated with a given document may be indicative of whether the given document is a news article or a scientific article. In another example, label data associated with a given document-query pair may be indicative of a relevance of the respective document to the respective query from the given document-query pair (for example, in a form of a click/no click information).

How label data is collected and/or generated and then stored in the database system 150 is not particularly limiting. In some cases, label data may be collected from human assessors that have been tasked with “labelling” documents and/or document-query pairs. In other cases, label data may be generated by one or more computer-implemented procedures executed by the server 106 (i.e., machine-generated data), without departing from the scope of the present technology.

### Server

The system 100 comprises the server 106 that may be implemented as a conventional computer server. In an example of an embodiment of the present technology, the server 106 may be implemented as a Dell™ PowerEdge™ Server running the Microsoft™ Windows Server™ operating system. Needless to say, the server 106 may be implemented in any other suitable hardware and/or software and/or firmware or a combination thereof. In the depicted non-limiting embodiment of present technology, the server 106 is a single server. In alternative non-limiting embodiments of the present technology, the functionality of the server 106 may be distributed and may be implemented via multiple servers.

Generally speaking, the server 106 is under control and/or management of a search engine provider (not depicted) such as, for example, an operator of the Yandex™ search engine. As such, the server 106 may be configured to host a given search engine for performing one or more searches responsive to queries submitted by users of the given search engine.

For example, the server 106 may receive the request 180 from device 102 indicative of the query submitted by the user 101. The server 106 may perform a search responsive to the submitted query for generating search results that are relevant to the submitted query. As a result, the server 106 may be configured to generate the response 190 indicative of the search results and may transmit the response 190 to the device 102 for display of the search results to the user 101 via the given browser application, for example.

The search results generated for the submitted query may take many forms. However, in one non-limiting example of the present technology, the search results generated by the server 106 may be indicative of documents that are relevant to the submitted query. How the server 106 is configured to determine and retrieve documents that are relevant to the submitted query will become apparent from the description herein.

The server 106 may also configured to execute a crawler application 120. Broadly speaking, the crawler application 120 may be used by the server 106 in order to “visit” resources accessible via the communication network 110 and to retrieve/download them for further use. For example, the crawler application 120 may be used by the server 106 in order to access the plurality of resource servers 108 and to retrieve/download documents representative of web pages hosted by the plurality of resource servers 108.

It is contemplated that the crawler application 120 may be periodically executable by the server 106 in order to retrieve/download documents that have been updated and/or became accessible over the communication network 110 since a previous execution of the crawler application 120.

In the context of the present technology, the server 106 is configured to employ one or more Machine Learning Algorithms (MLAs) for supporting a variety of search engine services. In at least some embodiments of the present technology, the server 106 is configured to execute a decision-tree based MLA 130. Broadly speaking, a given decision-tree based MLA is a machine learning model having one or more “decision trees” that are used (i) to go from observations about an object (represented in the branches) to conclusions about the object's target value (represented in the leaves). It should be noted that the decision-tree based MLA 130 may be used by the server 106 for performing a variety of tasks that depend on inter alia specific implementations of the present technology.

In some cases, the decision-tree based MLA 130 may be trained to determine, during in-use, a prediction value for a given object which is one of a discrete set of prediction values. For example, some decision-tree MLAs may be trained to determine, during in-use for a given document, whether the given document is a news article or a scientific article. In these cases, such decision-tree MLAs can be referred to as “classification” tree MLAs, since they are trained to perform a classification task on a given object. Needless to say, the server 106 may use object classification solutions in many ways for providing better search engine services.

In other cases, the decision-tree based MLA 130 may be trained to determine, during in-use, a prediction value for a given object which is one from a continuous interval of prediction values. For example, some decision-tree based MLAs may be trained to determine for a given document-query pair a relevance score ranging from “0” to “1”. In these cases, such decision-tree MLAs can be referred to as “regression” tree MLAs, since they are trained to perform a regression task on a given object. Needless to say, the server 106 may use relevance prediction solutions and other regression solutions in many ways for providing better search engine services.

Irrespective of whether the decision-tree based MLA 130 is used by the server 106 to perform a regression task or a classification task during in-use, the decision-tree based MLA 130 is first “built” (or trained) using a training dataset comprising training objects and respective target values. In those cases where the decision-tree based MLA 130 is trained for performing a classification task, a given target value for a given training object may be indicative of a ground-truth class associated with the given training object. In those cases where the decision-tree based MLA 130 is trained for performing a regression task, a given target value for a given training object may be indicative of a ground-truth value of a selected variable (for which the decision-tree based MLA 130 is trained to make predictions) for the given object.

To summarize, the implementation of the decision-tree based MLA 130 by the server 106 can be broadly categorized into two phases—a training phase and an in-use phase. First, the decision-tree based MLA 130 is trained during the training phase. Then, once the decision-tree based MLA 130 is built based on training data, the decision-tree based MLA 130 is actually employed by the server 106 using in-use data during the in-use phase. How the decision-tree based MLA 130 may be used during its in-use phase and how the decision-tree based MLA 130 may be trained based on a given training dataset will now be described in turn.

### In-Use Phase

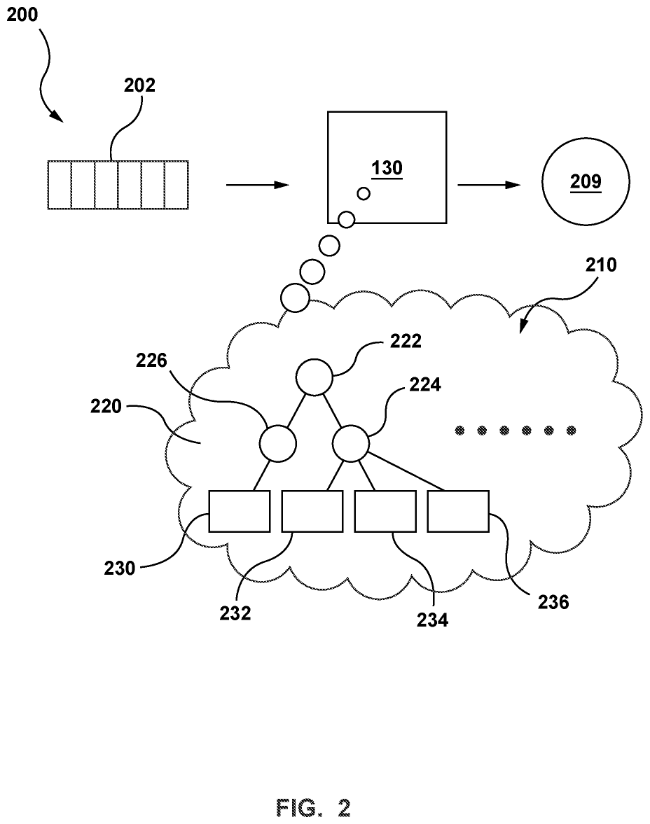

With reference to FIG. 2, there is depicted a representation 200 of a (single) current in-use iteration of the in-use phase of the (trained) decision-tree based MLA 130. Naturally, the in-use phase of the decision-tree based MLA 130 may comprise a large number of in-use iterations that are performed similarly to the current in-use iteration depicted in FIG. 2. Generally speaking, during the current in-use iteration, the decision-tree based MLA 130 is inputted with in-use data about a given in-use object. For example, a given in-use object may be a document. In another example, the given in-use object may be a document-query pair. Irrespective of a type of the in-use object, the in-use data may be indicative of one or more features representative of the given in-use object.

As illustrated in FIG. 2, the in-use data about the given in-use object may be in a form of a feature vector 202. It should be noted that the feature vector 202 may be representative of one or more features of different types.

In one non-limiting example, a given feature may be of a binary type, and hence may have a value of “0” or “1”. In another non-limiting example, a given feature may be of a real number type, and hence may have a real integer values and real non-integer values. In a further non-limiting example, a given feature may be of a categorical type, and hence may have a value representative of a sequence of characters such as a URL associated with the in-use object, a domain name, an IP address, a search query and/or a key word.

It should be noted that if the in-use object is a given document, the feature vector 202 may comprise one or more features associated with the given document. It should also be noted that if the in-use object is a given document-query pair, the feature vector 202 may comprise one or more features associated with the respective document from the given document-query pair, as well as one or more features associated with the respective query from the given document-query pair.

In some embodiments, in-use data for a given in-use object may be in a form of more than one feature vector. For example, if the in-use object is a given document-query pair, a first feature vector for the in-use object may comprise one or more features associated with the respective document from the given document-query pair, and a second feature vector for the in-use object may comprise one or more features associated with the respective query from the given document-query pair. Needless to say, how the given in-use object is processed for generating the feature vector 202 (and/or more than one feature vector) is not particularly limiting and may depend on inter alia a specific implementation of the present technology.

It should be noted that the (trained) decision-tree based MLA 130 is configured to output a “prediction” value 209 based on the feature vector 202. As it will become apparent from the description herein further below, a type of the prediction value 209 may depend on inter alia whether the decision-tree based MLA 130 is configured to perform a classification task or a regression task.

For example, in a case where the decision-tree based MLA 130 is trained to perform a classification task, the decision-tree based MLA 130 may be configured to predict based on the feature vector 202 whether the given in-use object (a given document, for example) is a news article or a scientific article. In these cases, the prediction value 209 may be indicative of either (i) a news article class, or (ii) a scientific article class. In another example, in a case where the decision-tree based MLA 130 is trained to perform a regression task, the decision-tree based MLA 130 may be configured to predict based on the feature vector 202 a relevance value for the given in-use object (a given document-query pair, for example). In these cases, the prediction value 209 may be a value ranging, for example, between “0” and “1”.

Also, as it will become apparent from the description herein further below, the decision-tree based MLA 130 is based on a plurality of generated trees 210 that are used, in combination, for generating the prediction value 209. Broadly speaking, a given generated tree has a tree-like structure with nodes and branches, and which is used to make a prediction about a given in-use object by employing the in-use data provided thereto.

For example, the plurality of generated trees 210 comprises a generated tree 220. As it can be seen, the generated tree 220 has a root node 222, a pair of first level nodes 224 and 226, and four leaf nodes 230, 232, 234, and 236. It should be noted that the root node 222 and the first level nodes 224 and 226 are associated with respective features and split values allowing to, in a sense, “decide” which branches of the generated tree 220 are to be followed by the in-use object for arriving to a given one of the leaf nodes 230, 232, 234, and 236 based on the in-use data.

For example, let it be assumed that the in-use object is being analyzed by the generated tree 220. The server 106 may be configured to identify a given feature value in the feature vector 202 associated with a given feature corresponding to the respective feature of the root node 222. The server 106 may be configured to compare this value against the respective split value of the root node 222. Depending on how this value compares to the respective split value, the in-use object will be, in a sense, “directed” towards either the first level node 224 or the first level node 226. Recalling that the root node 222 and level nodes are associated with respective features and split values, a similar logic can be performed at a corresponding first level node for, in a sense, “directing” the in-use object towards one of the four leaf nodes 230, 232, 234, and 236.

It should also be noted that each of the leaf nodes 230, 232, 234, and 236 is associated with a respective leaf value. Let it be assumed that based on the in-use data (e.g., feature values in the feature vector 202) about the in-use object, the in-use object is “directed” towards the leaf node 230. In this case, the prediction of the generated tree 220 for the given in-use object is the leaf value of the leaf node 230. Recalling that the decision-tree based MLA 130 is based on the plurality of generated trees 210, individual predictions by respective generated trees from the plurality of generated trees 210 (e.g., the leaf values of leaf nodes of respective generated trees towards which the given in-use object is directed) are used together, in combination, for determining the prediction value 209 for the given in-use object.

How the individual predictions by respective generated trees from the plurality of generated trees 210 are combined for determining the prediction value 204 may depend on the specific implementations of the present technology. In one example however, the individual predictions by respective generated trees from the plurality of generated trees 210 may be added (and potentially weighted) for determining the prediction value 209.

Also, generated trees may vary in size and complexity and, therefore, may comprise more than one level of level nodes and more than four leaf nodes. The size and complexity of generated trees may depend on inter alia specific implementations of the present technology. How the server 106 is configured to build the generated trees from the plurality of generated trees 210 via training will now be discussed in greater detail.

### Training Phase

One approach to building a decision-tree MLA is by using what is called “Gradient boosting”. Generally speaking, Gradient Boosting (GB) can be used for both classification and regression problems. This technique creates a model from numerous “weak learners” (individual generated trees) which are added in a stage wise fashion with each new tree focusing on the errors of the previous ones to generate a so-called “forest of trees”. This additive approach with a focus on errors made by the previous composition of the forest of trees and converts these weak learners into a single strong predictor.

Another approach of building a decision-tree MLA is by using a modified GB technique called “Stochastic Gradient Boosting”. Broadly speaking, during a given training iteration in accordance with the Stochastic Gradient Boosting (SGB) approach, a subset of training objects are randomly selected for building a tree for that iteration. This stochastic sampling of training data has been shown to be beneficial for increasing the predictive quality of so-trained decision tree MLAs.

A further approach of building a decision-tree MLA is by using a modified GB technique called “Stochastic Langevin Gradient Boosting”. Broadly speaking, during a given training iteration in accordance with the Stochastic Langevin Gradient Boosting (SGB) approach, “noise” is injected in a manner that, in a sense, allows “jumping” between different saddles of a non-convex loss function. Hence, subsequent training iterations may not necessarily “travel” towards a same potentially local minimum, and instead, will generally “travel” towards lower values of the non-convex loss function. The SGLB algorithm enables both exploitation and exploration of data during training so as to globally converge, even if employed with a non-convex loss function.

Developers of the present technology have realized at least some drawbacks associated with the SGLB approach. First, convergence of an SGLB model to an optimal solution may be slow and asymptotical. Second, during in-use, when an object “falls” into leaf nodes for which training data was not available, the object falls into a leaf node with a null leaf value, and the SGLB model provides a signal indicative of high certainty in its prediction. Developers have realized that a signal indicative of high certainty for such an out-of-domain object may be problematic during use of the SGLB model.

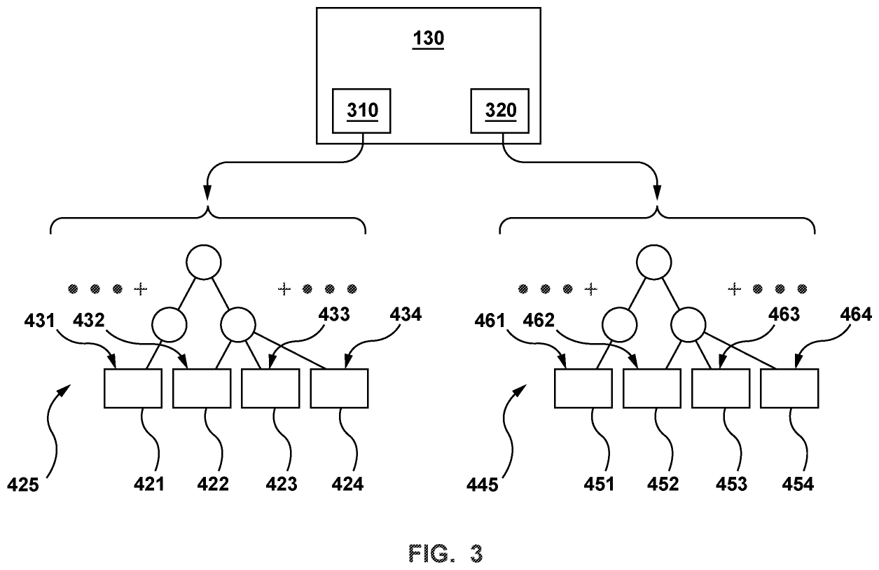

In the context of the present technology, developers have devised a Kernel Gradient Boosting (KGB) model in which different “types” of trees are built. With reference to FIG. 3, there is depicted the decision-tree based MLA 130 where the plurality of decision trees comprises a set of first decision trees 310 and a set of second decision trees 320.

In some embodiments, it can be said that the decision-tree based MLA 130 is a KGB model comprising a first sub-model formed from the set of first trees 310, and a second sub-model formed from the set of second trees 320. The set of first trees 310 may be referred to as a set of “kernel” trees, while the set of second trees 320 may be referred to as a set of GB trees. In some embodiments, the set of first trees 310 may include a single first tree. In other embodiments, the set of first trees 310 may be an ensemble of trees. It is contemplated that first trees in the set of first trees may have randomly determined structures. It is contemplated that second trees in the set of second trees 320 may be generated using a GBDT algorithm. In one non-limiting example, the second trees from the set of second trees may be generated using the SGLB framework. Developers of the present technology have realized that the KGB model 130 can converge comparatively faster to an SGLB model.

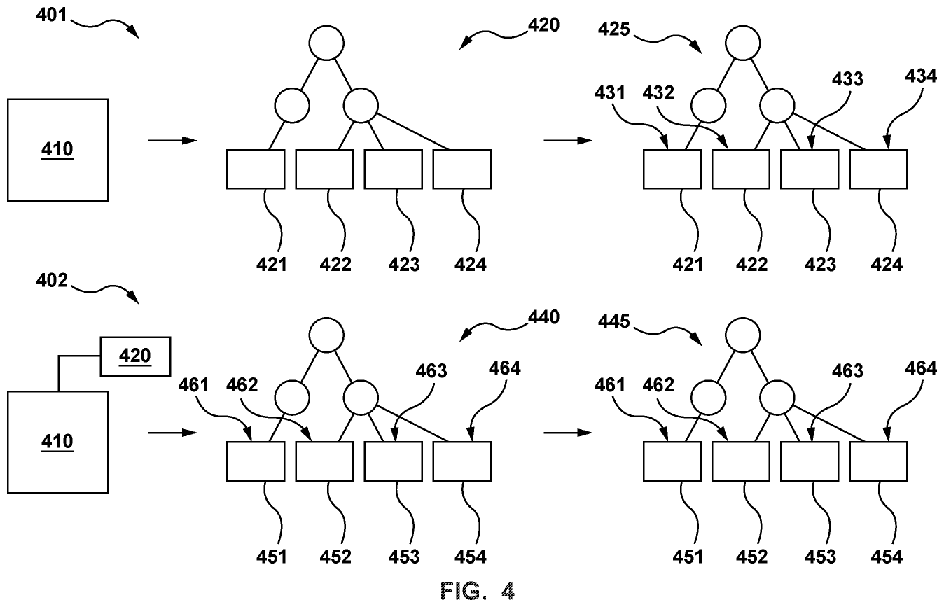

With reference to FIG. 4, there is depicted a single iteration 402 of training of a first tree 425 from the set of first trees 310 and a single iteration 404 of training a second tree 455 form the set of second trees 320. The server 106 may be configured to perform a large number of training iterations where, during a respective training iteration, a newly generated tree is built and added to the current generated trees of the decision-tree based MLA 130. In fact, the server 106 may be configured to perform a plurality of first training iterations similarly to the single iteration 402 for generating the set of first trees 310. Also, the server 106 may be configured to perform a plurality of second training iterations similarly to the single iteration 404 for generating the set of second trees 320. It should be noted that the example provided below will be directed to the decision-tree based MLA 130 being be built for performing regression tasks. However, it should be noted that a decision-tree MLA with classification trees may be built in a similar manner, without departing from the scope of the present technology.

The single iterations 402 and 404 will now be described in turn.

During the training iteration 402, the server 106 is configured to use a plurality of training objects 410 in order to generate the first tree 425. The server 106 is configured to generate a first tree structure 420 for the first tree 425. As mentioned above, the first tree structure 420 may be randomly generated by the server 106. In some embodiments, it can be said that the first tree structure 420 is a uniformly-distributed tree structure, meaning that the likelihood of the first tree 425 having the first tree structure 420 is equal to a likelihood of the first tree 425 having any other potential tree structure.

In some embodiments, the server 106 may generate the first tree structure 420 using a beam search algorithm. The split values for the first tree structure 420 may be determined based on the features from the plurality of training objects 410. It can be said that thresholds may be randomly selected during a splitting operation.

Once the server 106 inputs the plurality of training objects 410 into the first tree structure 420, training objects from the plurality of training objects “fall” into respective leaf nodes of the first tree structure 420. In this embodiment, the first tree structure 420 comprises leaf nodes 421 to 424. The server 106 is configured to generate leaf values 431 to 434 for the respective leaf nodes 412 to 424 based on a number of training objects from the plurality of training objects 410 that fell into corresponding leaf nodes from the leaf nodes 421 to 424. To that end, the server 106 may employ a first noise-inducing function.

It should be noted that the first noise-inducing function may be pre-selected such that a dispersion of leaf values in the corresponding leaf nodes is proportional to a size of the training dataset (e.g., a number of training objects in the plurality of training objects 410). In one implementation, the first noise-inducing function may generate random gaussian values for the respective leaf nodes with a dispersion equal to a size of the training dataset divided by a maximum value between (i) a number of objects in a corresponding leaf node and (ii) “1”.

Let it be assumed that a non-null number of training objects fell into the leaf nodes 421 to 423, while none of the training objects from the plurality of training objects 410 fell into the leaf node 424. In this example, the server 106 may generate random gaussian values for the leaf nodes 421 to 423 with a dispersion equal to a number of training objects from the plurality of objects 410 divided by a number of objects in a corresponding leaf node amongst the leaf nodes 421 to 423. The server 106 may use these random gaussian values as the respective leaf values 431 to 433. In this example, the server 106 may generate a random gaussian value for the leaf node 424 with a dispersion equal to a number of training objects from the plurality of objects 410 divided by “1”. The server 106 may use this random gaussian value as the respective leaf value 434. As a result, the first tree 425 having the first tree structure 420 with the leaf values 431 to 434 is a given tree that has exclusively non-null leaf values.

It can be said that during execution of the first iteration 402, noise is injected such that leaf values 431 to 434 of leaf nodes 421 to 424 are exclusively non-null. It is contemplated that the first noise-injecting function may yield a first option for leaf values for the leaf nodes 421 to 423 (in which training objects fell), and a second option for leaf value of the leaf node 424 (in which none of the objects fell). In one implementation of the present technology, the leaf values may be determined by the server 106 in accordance with the following formula:

$${θ}_{τ} ∼ 𝒩 ( {𝕆}_{{ℝ}^{{L}_{{v}_{τ}}}} , diag ( \frac{N}{max \{ {N}_{{v}_{τ}}^{( j )} , 1 \}} : j ∈ \{ 1 , … , {L}_{{v}_{τ}} \} ) ) \qquad ( 1 )$$

wherein θ_{τ} refers to leaf values, N refers to a total number of objects in the training dataset, N_{υ}_{_{τ}}^{(j)} refers to a number of objects falling in a given leaf node j, [symbol] refers to a null average for the function.

### Second Iteration

During the second iteration 404, the server 106 is configured to generate a second tree structure 440 and then generate leaf values 461 to 464 in order to generate the second tree 445. It should be noted that a training dataset comprises the plurality of training objects 410 and respective labels 415 representative of ground-truth about corresponding training objects. It is contemplated that although the plurality of training objects 410 are used during generation of the set of first trees (such as during generation of the first tree 425), the respective labels 415 are not actually used. In contrast, both the plurality of training objects 410 and the respective labels 415 are used during generation of the set of second trees (such as during generation of the second tree 445).

In some embodiments, a second tree 445 may be generated using a conventional GB method. In other embodiments, the second tree 445 may be generated using a randomized three structure generation process, such as a SGLB method, for example.

During the generation of the second tree 445, the server 106 is configured to apply a loss function for generating a plurality of estimated gradient values for respective prediction-target pairs. How the loss function is implemented is not limiting. As mentioned above, the decision-tree based MLA 130 may be trained for performing convex optimization, in which case the loss function may be implemented as a convex loss function. In some non-limiting examples, a convex loss function may be one of, but is not limited to: hinge loss, logistic loss, and squared error loss. Also, the decision-tree based MLA 130 may be trained for performing non-convex optimization, in which case the loss function may be implemented as a non-convex loss function. In other non-limiting examples, a non-convex loss function may be one of, but is not limited to: a 0-1 loss, Normalized Discounted Cumulative Gain (NDCG), and PFound.

Irrespective of a particular type of loss function used, a given one from the plurality of estimated gradient values is indicative of a difference between a target/label and a respective prediction or, simply put, the current prediction error. Needless to say, the specific type of error being determined depends on inter alia the type of loss function being used in various implementations of the present technology.

It is contemplated that the server 106 may be configured to use the plurality of estimated gradient values for generating a first plurality of noisy estimated gradients during the generation process of the second tree 445. For example, the server 106 may be configured to apply an other noise-injecting function onto the plurality of estimated gradient values for generating the second tree structure 440. In another example, the an additional noise-injecting function may be applied onto the plurality of estimated gradient values for generating the leaf values of the leaf nodes of the second tree 445. How the other noise-injecting function, and the additional noise-injecting function can be implemented is described in greater detail in an a yet unpublished article, entitled “Stochastic Gradient Langevin Boosting”.

Developers of the present technology have realized that when a given in-use object has been encountered during training of the KGB model, the set of second trees is responsible to generate a “correct” prediction for this in-use object. However, when the given in-use object has not been encountered during training, the first set of trees is responsible for providing an indication of uncertainty of prediction.

In some embodiments, the server 106 may include one or more processors configured to execute a method 500. At least some steps of the method 500 will now be described in greater details.

### STEP 502: Generating a First Tree Using the Plurality of Training Objects

The method 500 begins at step 502 with the processor configured to, during a first training iteration of the decision-tree based MLA, generating a first tree using the plurality of training objects. For example, the processor may generate a first tree 425.

During a sub-step 510, the processor may generate a first tree structure with a first leaf node and a second leaf node. At least one from the plurality of training objects falls in the first leaf node and none fall in the second leaf node.

During a sub-step 510, the processor may generate a first leaf value for the first leaf node and a second leaf value for the second leaf node. The first and second leaf values are generated by the processor based on a first noise-inducing function such that the first leaf value and the second leaf value are non-null leaf values. For example, the processor may employ equation (1) for generating the leaf values for the first tree.

It is contemplated that in some embodiments, the first tree structure has a plurality of leaf nodes including the first leaf node and the second lead node, and all leaf values assigned to the plurality of lead nodes using the first noise-inducing function are exclusively non-null leaf values. In other embodiments, the first tree structure may be randomly selected and/or be a uniformly-distributed tree structure. In some embodiments, the step 502 may be repeated a plurality of times for generate a plurality of first trees during a plurality of first training iterations.

STEP 504: Generating a Second Tree Using the Training Dataset

The method 500 continues to step 504 with the processor configured to, during a second training iteration of the decision-tree based MLA, generating a second tree using the training dataset. For example, the processor may generate a second tree 445.

The processor may be configured during a sub-step 520 generate a second tree structure with a third leaf node. The second tree structure may be generated by the processor using a random structure generation process.

The processor may be configured during a sub-step 502 generate a third leaf value to the third leaf node, the third leaf value being based on an estimated gradient value of a loss function for at least one training object falling in the third leaf node. The second tree may be generated using a GB algorithm with a randomized structure generation process, such as a process of the SGLB algorithm, for example. In some embodiments, leaf value assignment on the second tree may be based on known techniques.

In some embodiments, the decision-tree based MLA is being trained for performing one of a regression task and classification task during an in-use phase of the decision-tree based MLA. It is contemplated that the first noise-inducing function may be a function having a null average and a finite distribution. In further embodiments, the loss function may be at least one of a 0-1 loss, Normalized Discounted Cumulative Gain (NDCG), and PFound. In additional embodiments, the loss function may be at least one of a hinge loss, logistic loss, and squared error loss.

It is contemplated that the processor may repeat the step 504 a number of times to generate a plurality of second trees during a plurality of second training iterations.

### STEP 506: Storing the First and the Second Tree of the Decision-Tree Based MLA in a Storage

The method 500 ends at step 506 with the processor configured to store the first and the second tree in a storage. It should be noted that the processor may be configured to store a first sub-model and a second sub-model in the storage, which contain a first plurality of trees and a second plurality of trees, respectively.

It should be expressly understood that not all technical effects mentioned herein need to be enjoyed in each and every embodiment of the present technology. For example, embodiments of the present technology may be implemented without the user enjoying some of these technical effects, while other embodiments may be implemented with the user enjoying other technical effects or none at all.

Some of these steps and signal sending-receiving are well known in the art and, as such, have been omitted in certain portions of this description for the sake of simplicity. The signals can be sent-received using optical means (such as a fibre-optic connection), electronic means (such as using wired or wireless connection), and mechanical means (such as pressure-based, temperature based or any other suitable physical parameter based).

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A method of training a decision-tree based Machine Learning Algorithm (MLA), the method executable by a processor having access to a training dataset, the training dataset comprising a plurality of training objects and a plurality of target values for respective ones from the plurality of training objects, the method comprising:
during a first training iteration of the decision-tree based MLA:
generating, by the processor, a first tree using the plurality of training objects, the generating including:
generating a first tree structure with a first leaf node and a second leaf node, at least one from the plurality of training objects falling in the first leaf node and none falling in the second leaf node; and
generating a first leaf value for the first leaf node and a second leaf value for the second leaf node, the first and second leaf values being based on a first noise-inducing function such that the first leaf value and the second leaf value are non-null leaf values;
during a second training iteration of the decision-tree based MLA:
generating, by the processor, a second tree using the training dataset, the generating including:
generating a second tree structure with a third leaf node; and
generating a third leaf value to the third leaf node, the third leaf value being based on an estimated gradient value of a loss function for at least one training object falling in the third leaf node;
storing, by the processor, the first and the second tree of the decision-tree based MLA in a storage.

2. The method of claim 1, wherein the first tree structure has a plurality of leaf nodes including the first leaf node and the second lead node, and wherein all leaf values assigned to the plurality of lead nodes using the first noise-inducing function are exclusively non-null leaf values.

3. The method of claim 1, wherein the first tree structure is a uniformly-distributed tree structure.

4. The method of claim 1, wherein the second tree structure is generated using a second noise-inducing function.

5. The method of claim 1, wherein the generating the second tree comprises generating, by the server, the second tree structure using a Gradient Boosting (GB) technique.

6. The method of claim 5, wherein the GB technique includes a randomized tree generation process.

7. The method of claim 1, wherein the method comprises generating, by the processor, a plurality of first trees during a plurality of first training iterations, the first training iteration being one from the plurality of first training iterations, the first tree being one from the plurality of first trees.

8. The method of claim 1, wherein the method comprises generating, by the processor, a plurality of second trees during a plurality of second training iterations, the second training iteration being one from the plurality of second training iterations, the second tree being one from the plurality of second trees.

9. The method of claim 1, wherein the decision-tree based MLA is being trained for performing a regression task during an in-use phase of the decision-tree based MLA.

10. The method of claim 1, wherein the decision-tree based MLA is being trained for performing a classification task during an in-use phase of the decision-tree based MLA.

11. The method of claim 1, wherein the first noise-inducing function is a function having a null average and a finite distribution.

12. The method of claim 1, wherein the loss function is at least one of a 0-1 loss, Normalized Discounted Cumulative Gain (NDCG), and PFound.

13. The method of claim 1, wherein the loss function is at least one of a hinge loss, logistic loss, and squared error loss.

14. A processor for training a decision-tree based Machine Learning Algorithm (MLA), the processor having access to a training dataset, the training dataset comprising a plurality of training objects and a plurality of target values for respective ones from the plurality of training objects, the processor being configured to:
during a first training iteration of the decision-tree based MLA:
generate a first tree using the plurality of training objects, the generating including:
generate a first tree structure with a first leaf node and a second leaf node, at least one from the plurality of training objects falling in the first leaf node and none falling in the second leaf node; and
generate a first leaf value for the first leaf node and a second leaf value for the second leaf node, the first and second leaf values being based on a first noise-inducing function such that the first leaf value and the second leaf value are non-null leaf values;
during a second training iteration of the decision-tree based MLA:
generate a second tree using the training dataset, the generating including:
generate a second tree structure with a third leaf node; and
generate a third leaf value to the third leaf node, the third leaf value being based on an estimated gradient value of a loss function for at least one training object falling in the third leaf node;
store the first and the second tree of the decision-tree based MLA in a storage.

15. The processor of claim 14, wherein the first tree structure has a plurality of leaf nodes including the first leaf node and the second lead node, and wherein all leaf values are generated for the plurality of lead nodes using the first noise-inducing function are exclusively non-null leaf values.

16. The processor of claim 14, wherein the first tree structure is a uniformly-distributed tree structure.

17. The processor of claim 14, wherein the second tree structure is generated using a second noise-inducing function.

18. The processor of claim 14, wherein the processor is configured to generate a plurality of first trees during a plurality of first training iterations, the first training iteration being one from the plurality of first training iterations, the first tree being one from the plurality of first trees.

19. The processor of claim 14, wherein the processor is configured to generate a plurality of second trees during a plurality of second training iterations, the second training iteration being one from the plurality of second training iterations, the second tree being one from the plurality of second trees.

20. The processor of claim 14, wherein the first noise-inducing function is a function having a null average and a finite distribution.
